(19) United States
(12) Patent Application Publication
(10) Pub. No.: US 2005/0256868 A1
(43) Pub. Date: Nov. 17, 2005

(54) Document search system

(76) Inventors: Michael J. Shelton, Boise, ID (US); Chad Stevens, Boise, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/084,301

(22) Filed: Mar. 17, 2005

Related U.S. Application Data
(60) Provisional application No. 60/554,306, filed on Mar. 17, 2004.

(51) Int. Cl. G06F 17/30

(52) U.S. Cl. 707/5

(57) ABSTRACT

A document search system including an input device configured to derive an electronic source document from an original hardcopy document, a processor configured to generate an electronic search report based on search criteria defined in relation to the electronic source document, and an output device configured to automatically present the electronic search report.

### CROSS-REFERENCE TO RELATED APPLICATION

This application claims priority from copending U.S. Provisional Patent Application Ser. No. 60/554,306, which was filed on Mar. 17, 2004 and entitled “Document Search System,” the completed disclosure of which is incorporated herein by reference for all purposes.

### BACKGROUND

Although electronic documents are utilized in almost every industry today, hardcopy (or paper) documents continue to be produced, copied, and circulated using photocopiers, fax machines, and other devices. Such hardcopy documents may contain a wealth of useful information, and thus remain important in today's information culture.

However, hardcopy documents may be quite voluminous, potentially leading to difficulty in managing the information contained therein. It is possible, for example, for a user to be interested in only a small portion of the information contained in a hardcopy document. While some types of documents may include indexes or section headings to help guide a user through the document, such indexes typically add to the size of the document and may not allow meaningful searching of the document because of limitations inherent in any pre-prepared guide. Users thus still may face re-reading substantial portions of a document in order to identify information of interest.

In contrast to hardcopy documents, many electronic documents may be rapidly searched upon a user providing a search request to a search engine. The search request may include words, partial words, phrases, etc., and may employ search logic such as boolean operators, proximity operators, “followed by” operators, etc. Based on such a search request, a search engine may search the electronic document for “hits,” (e.g., portions of the electronic document that correlate with or correspond to the search criteria, according to the particular search logic used by the search engine). These “hits” may be brought to the user's attention, and the user may view the “hits” within the electronic document. Depending on the particular search engine used, it may be necessary to negotiate multiple screens or windows during each print request.

### BRIEF DESCRIPTION OF THE DRAWINGS

FIG. 1 is a high level schematic illustration of a network environment including a multi-functional device employing a document search system, in accordance with an embodiment of the invention.

FIG. 2 is a block diagram of document search system, according to an embodiment of the invention.

FIG. 3 is a flow diagram of a method of searching a document, according to an embodiment of the invention.

### DETAILED DESCRIPTION

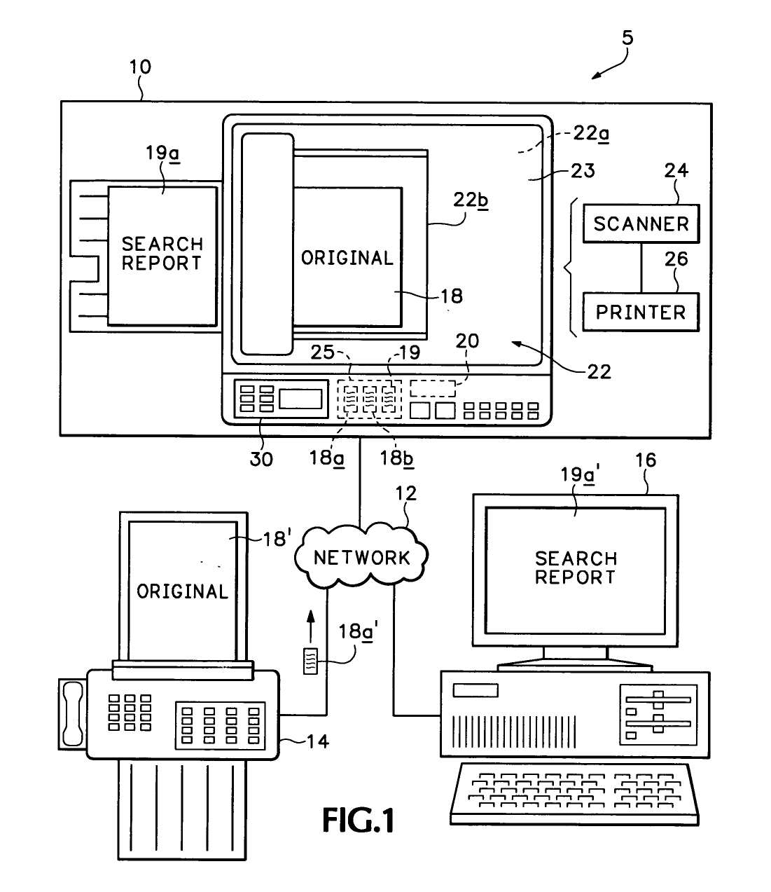

Referring initially to FIG. 1, a network environment 5 is depicted, such a network environment includes one or more multi-functional devices. In particular, network environment 5 includes a copy machine 10 connected via a communications network 12 to a facsimile machine 14 and a computer 16. It will be appreciated that the network environment may include additional copiers, facsimile machines and computers, as well as various other network devices (e.g., scanners, printers, etc.).

In the present illustration, copy machine 10 will be understood to include both a scanner and an imaging device, and thus may be referred to generally as a multi-functional device. Facsimile machine 14 may include both a scanner and a printer, and thus also may be referred to generally as a multi-functional device. As used herein, the term “multi-functional device” is not limited to copy machines or facsimile machines, or even to network devices, but rather is intended to designate a device characterized by plural document-processing functions (e.g., both scanning and printing). Such multi-functional devices also may be referred to as “all-in-one” devices or “printer-copier-fax” devices, regardless of style or size.

Communications network 12 may take the form of a local area network (LAN), a wide area network (WAN) such as the Internet, or any other network or combination of networks capable of providing for communication between network devices, such as copy machine 10, facsimile machine 14, and/or computer 16. In the depicted embodiment, although only unidirectional communication of electronic documents is described, it is to be understood that bi-directional communication is possible throughout network environment 5.

As indicated, copy machine 10 may be adapted to scan hardcopy documents, print hardcopy documents and/or produce copies of hardcopy documents. In connection with these basic functions, the copy machine 10 may be configured to produce corresponding electronic documents and/or to process electronic documents, whether produced by a scanner onboard the copy machine 10, or produced by another device. For example, where the copy machine 10 forms a part of a network environment, as shown in FIG. 1, the copy machine may be adapted to receive electronic documents for processing, and/or to send processed electronic documents for presentation (e.g., printing or display) by another network device.

In FIG. 1, an electronic source document 18a may be derived from a hardcopy document, such as original hardcopy document 18. The electronic source document 18a thus may be processed by an onboard processor 20, and/or communicated via communications network 12 to one or more other network devices. Likewise, a remote electronic source document 18a′ may be derived from a remote hardcopy document, such as remote original hardcopy document 18′, and communicated via communications network 12 to copy machine 10 for processing by onboard processor 20.

In the exemplary embodiment of FIG.1, it will be noted that copy machine 10 is configured to receive original hardcopy document 18 via a media input 22, which may comprise a portion of the copy machine, such as a scanner window 22a (hidden beneath cover 23), or may take the form of a feeder, such as automatic document feeder (ADF) 22b. In either case, original hardcopy document 18 may be a single-page document or a multi-page document, and may be of virtually any shape or size.

Upon receiving original hardcopy document 18, copy machine 10 may employ an input device, such as onboard scanner 24, to scan the original hardcopy document, thereby producing electronic source document 18a. Electronic source document 18a may be at least temporarily stored in onboard memory 25 as an image file (e.g., a bitmap), and/or may be made available for processing by onboard processor 20. The electronic source document 18a also may be presented to a user, using an output device, such as onboard printer 26.

As will be explained further below, onboard processor 20 may be configured to convert an image file to a text-recognizable file (text, rich text, etc.), thereby producing a searchable electronic document 18b using optical character recognition (OCR) or similar technology. The searchable electronic document, in turn, may be stored in memory 25, and/or processed further to produce an electronic search report 19. The electronic search report 19 also may be stored in memory 25, as shown, and/or may be sent to onboard printer 26 for printing. As indicated, a resultant document in the form of a hardcopy search report 19a thus may be produced.

Alternatively or additionally, the electronic search report 19 may be communicated to another device via communications network 12. In FIG. 1, for example, electronic search report 19 may be communicated to computer 16 for presentation. Computer 16, in turn, may be configured to produce a visual search report 19a′. Although not particularly shown, it will be appreciated that other devices, and other forms of presentation, also may be employed.

Operation of a multi-functional device such as copy machine 10 may be directed via a control panel 30, which may employ one or more user-input features (e.g., buttons, a touch screen, or similar features). With these features, a user may enter information, or select desired functions, to effect scanning of an original hardcopy document, searching of an electronic document and/or printing of a search report. Alternatively or additionally, a multi-functional device may be directed using another device, such as network computer 16.

In one embodiment, a stand-alone multi-functional device may include a keyboard or keypad for entry of search criteria and initiation of a search request. Upon initiating the search request, an original hardcopy document may be scanned by the onboard scanner, and automatically converted to a searchable electronic format, if necessary. The resulting searchable electronic document thus may be searched, automatically, using the entered search criteria, and an electronic search report produced. The electronic search report then may be presented, automatically, to the user. The search report may be presented on a display screen of the control panel and/or presented as printed, automatically, a hardcopy search report produced by the onboard printer.

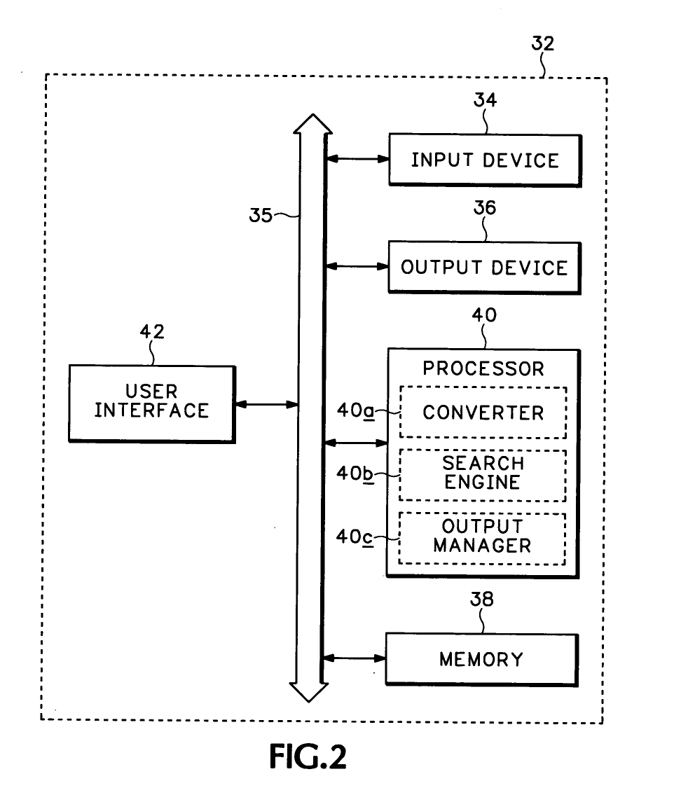

Turning now to FIG. 2, a block diagram of an exemplary document search system is provided, the document search system being indicated generally at 32. As shown, document search system 32 may include an input device 34 and an output device 36 linked by a bus 35.

As indicated in connection with the exemplary embodiment of FIG. 1, the input device 34 may take the form of a scanner 14 configured to derive an electronic source document 18a from an original hardcopy document. Such electronic source document 18a may take the form of an image file, such as a bitmap, and may be stored, at least temporarily, in memory 38. Operation of the scanner 14 may be controlled by a processor 40, with or without further direction from a user.

Processor 40 also may be employed to direct processing of the electronic source document 18a, including directing performance of a desired search. In one embodiment, processor 40 may be provided with user direction via a user interface 42, which may take the form of a control panel, or the like. The user thus may enter search criteria defined in relation to the electronic source document 18a and interpretable by the processor 40 to effect searching of the electronic source document 18a, as will be described below.

For example, upon identifying an electronic source document 18a of interest, whether by scanning an original hardcopy document 18 to create the electronic source document 18a, by receiving the electronic source document 18a (already in electronic form) via a communications link, or by some other means, the identified electronic source document 18a may be prepared for processing. Accordingly, the identified electronic source document 18a may be reviewed to determine whether it is in a searchable format. If the identified electronic source document 18a is determined to be in such a searchable format (e.g., PDF text, WORD®, text, rich text, etc.), the search may begin. However, if the identified electronic source document 18a is determined not to be in a searchable format, processor 40 may be employed to convert the electronic source document 18a from a non-searchable format to a searchable format.

As indicated, processor 40 may employ a converter 40a configured to convert an image file (derived from the hardcopy document) to a searchable text file. Converter 40a may take the form of optical character recognition (OCR) software, firmware and/or hardware, or any other type of character, design or pattern recognition software, firmware and/or hardware. It will be appreciated that optical character recognition may involve recognition of printed or written text characters received by photo-scanning of the text. The text may be analyzed character-by-character for translation of characters into character codes, such as American Standard Code for Information Interchange (ASCII), which is commonly used in data processing.

Processor 40 also may employ a search engine 40b, which may be configured to utilize specialized search logic to find and identify “hits” (e.g., portions) in the electronic source document 18a that correlate with or correspond to search criteria. The search engine 40b thus may generate an electronic search report 19 that includes (or identifies) excerpts of the original hardcopy document 18 meeting the search criteria. Those of skill in the art will be familiar with the myriad search logic terms that allow a user to define search criteria as precisely or as imprecisely as desired.

An output manager 40c may be employed to present the electronic search report 19, generated by search engine 40b. The search report 19 may be presented automatically upon initiating the search, or may be presented in accordance with further user direction regarding presentation format and scope. As described above, the search report 19 may take the form of a printed hardcopy document, a displayed electronic document 19a′, or both. Where the search report 19 takes the form of an electronic document, the search report may be stored in memory 38 and/or communicated to an output device such as a printer, or a display. Such communication may take the form of an email message sent to remote printer or computer via a communications network (as indicated generally in FIG. 1). The communication may be sent upon completing the search, or at a later time as part of a larger search report.

By way of example, it will be appreciated that a user may desire to search a document for the term “apple.” A hardcopy source document thus may be placed in a document scanner, and the term “apple” entered via a user interface. Upon initiating the scan (as by entering a “start” command), the scan may commence. The resulting scanned image may be automatically converted by a converter 40a to a searchable electronic document, and then automatically searched by a search engine 40b to identify portions of the searchable electronic document that include the search term, “apple”. An output manager 40c then may automatically produce an electronic search report 19 including (or identifying) portions of the hardcopy source document which include the search term, “apple”. The electronic search report 19 then may be automatically printed, or otherwise presented, to a user. The electronic search report 19 may include reprints of sentences, paragraphs, pages and/or sections (based on user-selection) of the hardcopy source document which include the search term, “apple”.

As noted above, an electronic document derived from a source document (e.g., the aforementioned scanned image, or corresponding searchable electronic source document) may be saved to memory (e.g., memory 38) for later access. Thus, should a user desire to search a particular hardcopy source document again (with the same or a different search request) the hardcopy document need not be scanned again, and converted to a searchable format again. Similarly, an electronic search report 19 derived from the searchable electronic document may be saved to memory for later access.

Memory 38 may be configured to store electronic documents permanently, or temporarily, in accordance with user direction and/or system needs. For example, memory 38 may be configured to store only the most recently generated electronic documents, may be configured to store electronic documents for a period of time after creation, or may be configured to store electronic documents indefinitely.

Users may access electronic search reports 19 via a computer 16 or other suitable device that is in communication with the document search system. For example, it will be appreciated that an electronic search report 19 may accessed by a remote computer for visual display. Similarly, an electronic search report 19 may be forwarded to a network printer, or network copy device, etc. for hardcopy presentation. Alternatively, or additionally, an electronic search report 19 may be forwarded to a remote facsimile machine (via a telecommunications network) for hardcopy presentation by such facsimile machine. Forwarding of the electronic search report 19 for presentation (printed or otherwise) may be effected automatically by the output manager 40c, or based on user direction in connection with the search request.

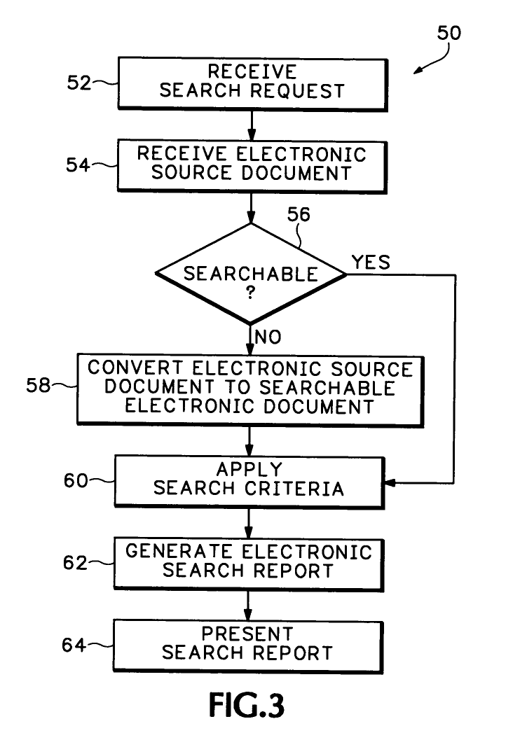

FIG. 3 is a flow diagram showing, generally at 50, a method of searching a document. As indicated at 52, a search request is received, such request typically being made by entering search criteria via a user interface (42; FIG. 2), as described above. It will be appreciated, however, that the search request may be made automatically, for example, by employing computer software, firmware, or other device. The search request generally includes search criteria (or search logic) useful in identifying “hits” as described above.

An electronic source document (18a; FIG. 1) is received at 54. As noted, the electronic source document 18a may be received from an associated scanner 14, which scans an original hardcopy document 18, or may be received electronically from a remote device via a communication link. If received from a scanner 14, the electronic source document 18a typically will take the form of an image file (e.g., a bitmap). If received electronically, the electronic source document 18a may be an image file (which generally is not directly searchable), or may be a text file (e.g., PDF text, WORD®, text, rich text, etc.). Either type of file may be stored in memory for later processing, as described below.

At 56, a determination is made regarding whether the electronic source document 18a is searchable. If the electronic source document 18a is not searchable, the electronic source document is converted to a searchable electronic document, at 58, and the search criteria is applied to the searchable electronic document, at 60. If the electronic source document 18a is searchable, conversion of the electronic source document 18a is bypassed, and the search logic is applied directly to the electronic source document. It will be appreciated that the aforementioned determination, conversion and application of search logic may be achieved automatically, if desired.

Based on the results of the search, an electronic search report 19 is generated, at 62. As noted above, the electronic search report 19 may include excerpts from the searchable electronic document and/or may include references to relevant portions of the searchable electronic document. At 64, the search report 19 may be presented, whether by printing the electronic search report to present a hardcopy search report 19a, or by displaying the electronic search report on a display to present a visual search report 19a′. Such presentation may be effected automatically upon generating the search report and/or may be effected by user directive. For example, as noted above, an electronic search report 19 may be stored in memory, and accessed on demand.

It will be appreciated that the size and character of excerpts presented in the electronic search report may be user-selected. Moreover, the electronic search report may include additional descriptive information, such as a line number, page number, section and/or chapter for each excerpt. The descriptive information may further include the title of the document from which the excerpt is taken. This may be desirable, for example, if more than one document is searched at the same time. This descriptive information may be input by a user upon initiating a search, or taken from the source document directly. Thus, a user may be able to provide presentation directives that specify a desired excerpt size as well as what descriptive information, if any, is to be included in the electronic search report. It also may be desirable for the user to be provided with other options. For example, a user may desire to provide presentation directives regarding the method of delivery for the search results. This may include the location where the search results should be output, the manner in which the search results are output, etc. Some or all of these options may be available to the user at the time the search request is input to the multi-functional device.

It will be appreciated that the aforementioned method may be completed entirely by a multi-functional device (such as the aforementioned copy machine), or may be completed by plural devices (e.g., a printer and a scanner) related by a communications network. Similarly, it will be appreciated that the aforementioned document search system may be housed in a unitary multi-functional device (such as the aforementioned copy machine), or may be distributed across a network environment including distinct network devices capable of performing one or more of the operations described herein.

Although the present disclosure includes specific embodiments, these embodiments are not to be considered in a limiting sense as numerous variations are possible. The following claims particularly point out certain combinations and subcombinations regarded as novel and nonobvious. Other combinations and subcombinations of features, functions, elements, and/or properties may be claimed through amendment of the present claims or through presentation of new claims in this or a related application. Such claims, whether broader, narrower, equal, or different in scope to the original claims, are regarded as included within the subject matter of the present disclosure.

1. A document search system comprising:
an input device configured to derive an electronic source document from an original hardcopy document;
a processor configured to generate an electronic search report based on search criteria defined in relation to the electronic source document; and
an output device configured to automatically present the electronic search report.

2. The document search system of claim 1, wherein the input device is a scanner configured to scan the original hardcopy document.

3. The document search system of claim 2, wherein the electronic source document is an image file, and wherein the processor is configured to convert the image file to a text file.

4. The document search system of claim 1, wherein the electronic source document is a non-searchable electronic document, and wherein the processor is configured to convert the non-searchable electronic document to a searchable electronic document.

5. The document search system of claim 1, further comprising a user interface configured to receive search criteria used in generating the electronic search report.

6. The document search system of claim 5, wherein the user interface is further configured to receive presentation directives used in presenting the electronic search report.

7. The document search system of claim 1, wherein the electronic search report includes excerpts of the original hardcopy document meeting the search criteria.

8. The document search system of claim 1, wherein the electronic search report identifies excerpts of the original hardcopy document meeting the search criteria.

9. The document search system of claim 1, wherein the output device is a display screen configured to display the electronic search report.

10. The document search system of claim 1, wherein the output device is a printer configured to print a hardcopy search report corresponding to the electronic search report.

11. The document search system of claim 1, wherein the input device, the processor and the output device collectively define a unitary multi-functional device.

12. The document search system of claim 1, wherein the input device, the processor and the output device are housed in a copy machine.

13. The document search system of claim 1, wherein the input device, the processor and the output device are distributed across a network environment.

14. A multi-functional device comprising:
a scanner configured to scan an original hardcopy document, thereby creating an electronic image file;
a processor configured to convert the electronic image file to a searchable text file, and thereafter, to generate an electronic search report based on user-defined search criteria; and
a printer configured to produce a hardcopy search report upon generating the electronic search report.

15. The multi-functional device of claim 14, further comprising a user interface configured to receive the user-defined search criteria.

16. The multi-functional device of claim 15, wherein the user interface is further configured to receive presentation directives.

17. The multi-functional device of claim 14, wherein the hardcopy search report includes excerpts of the original hardcopy document meeting the user-defined search criteria.

18. The multi-functional device of claim 14, wherein the electronic search report identifies excerpts of the original hardcopy document meeting the user-defined search criteria.

19. The multi-functional device of claim 14, wherein the multi-functional device is a stand-alone copy machine.

20. The multi-functional device of claim 14, wherein the multi-functional device forms a part of a network environment.

21. A method of searching a document comprising:
receiving an electronic source document derived from an original hardcopy document;
applying search criteria to the electronic source document;
generating an electronic search report based on the applied search criteria; and
presenting the electronic search report.

22. The method of claim 21, wherein receiving the electronic source document includes scanning the original hardcopy document to create an image file.

23. The method of claim 22, which further comprises converting the image file to a searchable text file.

24. The method of claim 23, wherein converting the image file to a searchable text file includes employing optical character recognition of the image file.

25. The method of claim 21, wherein the electronic source document is a searchable text file.

26. The method of claim 21, wherein receiving the electronic source document includes receiving the electronic source document from a remote device via a communications network.

27. The method of claim 21, which further comprises determining whether the electronic source document is searchable, and if the electronic source document is not searchable, converting the non-searchable electronic source document to a searchable electronic source document.

28. The method of claim 27, which further comprises storing the searchable electronic source document in memory.

29. The method of claim 21, which further comprises receiving user-defined search criteria via a user interface.

30. The method of claim 21, wherein applying search criteria includes identifying excerpts of the original hardcopy document meeting the user-defined search criteria.

31. The method of claim 30, wherein the electronic search report includes excerpts of the original hardcopy document identified as meeting the user-defined search criteria.

32. The method of claim 21, wherein presenting the electronic search report includes printing a hardcopy search report derived from the electronic search report.

33. The method of claim 21, wherein presenting the electronic search report includes sending the electronic search report to a remote device via a communications network.

34. The method of claim 21, which further comprises storing the electronic search report in memory.

35. The method of claim 21, wherein receiving the electronic source document, applying search criteria, generating the electronic search report, and presenting the electronic search report are completed by a unitary multi-functional device.

36. A multi-functional device configured to perform the method of claim 20.

37. A hardcopy document searching method comprising:
scanning an original hardcopy document to create an image file;
automatically converting the image file to a searchable text file;
automatically applying user-defined search criteria to the searchable text file;
automatically generating an electronic search report based on the applied user-defined search criteria; and
automatically printing a hardcopy search report derived from the electronic search report.

38. The hardcopy document searching method of claim 37, which further comprises receiving user-defined search criteria via a user interface.

39. The hardcopy document searching method of claim 37, which further comprises storing the searchable text file in memory.

40. The hardcopy document searching method of claim 37, wherein applying user-defined search criteria includes identifying excerpts of the original hardcopy document meeting the user-defined search criteria.

41. The hardcopy document searching method of claim 40, wherein the hardcopy search report includes excerpts of the original hardcopy document identified as meeting the user-defined search criteria.

42. The hardcopy document searching method of claim 37, which further comprises storing the electronic search report in memory.

43. The hardcopy document searching method of claim 37, wherein scanning the original hardcopy document, converting the image file to a searchable text file, applying user-defined search criteria, generating the electronic search report, and printing the hardcopy search report are completed by a unitary multi-functional device.

44. A multi-functional device comprising:
means for converting an original hardcopy document into an electronic source document;
means for automatically searching the electronic source document based on search criteria to generate an electronic search report; and
means for automatically presenting the electronic search report.

45. A program storage device readable by a machine, the storage device tangibly embodying a program of instructions executable by the machine to perform a hardcopy document searching method, the method comprising:
deriving an electronic source document from an original hardcopy document;
automatically searching the electronic source document based on user-defined search criteria to generate an electronic search report; and
automatically presenting the electronic search report to a user.
